(19) United States
(12) Patent Application Publication
(10) Pub. No.: US 2025/0193688 A1
(43) Pub. Date: Jun. 12, 2025

(54) MEASUREMENT AND INITIAL ACCESS FOR MULTI-OPERATOR SPECTRUM SHARING

(71) Applicant: QUALCOMM Incorporated, San Diego, CA (US)

(72) Inventors: Kazuki TAKEDA, Tokyo (JP); Jing LEI, San Diego, CA (US); Kianoush HOSSEINI, San Diego, CA (US)

(21) Appl. No.: 18/532,656

(22) Filed: Dec. 7, 2023

(51) Int. Cl. H04W 16/14; H04L 5/00; H04W 28/26; H04W 56/00; H04W 84/04

(52) U.S. Cl. CPC H04W 16/14; H04L 5/0051; H04W 28/26; H04W 56/0015; H04W 84/042

(57) ABSTRACT

Aspects of the present disclosure relate to wireless communications, and more particularly, to techniques for measurement and initial access for sharing spectrum between mobile network operators.

### FIELD OF THE DISCLOSURE

Aspects of the present disclosure relate to wireless communications, and more particularly, to techniques for measurement and initial access for sharing spectrum between mobile network operators.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a first network entity. The method includes participating in spectrum sharing to communicate with at least a first user equipment (UE) subscribed to the first mobile network, wherein the first network entity is associated with at least a first identifier (ID) of a first mobile network having first frequency resources and the spectrum sharing allows the first network entity to use second frequency resources of a second mobile network; transmitting first reference signals (RSs) on the first frequency resources; and coordinating with a second network entity for transmission of second RSs on the second frequency resources, wherein the second network entity is associated with the second mobile network.

Another aspect provides a method for wireless communications by a user equipment (UE). The method includes receiving, while the UE is subscribed to a first mobile network with first frequency resources and associated with at least a first identifier (ID), reference signals (RSs) on second frequency resources of a second mobile network; and participating in spectrum sharing to communicate with the first mobile network using the second frequency resources after receiving the RSs.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIGS. 5A and 5B depict an example of spectrum sharing between multiple mobile network operators.

FIGS. 6A and 6B depict different types of deployments for spectrum sharing between multiple mobile network operators.

FIG. 7 depicts a call flow diagram illustrating an example of multi-operator spectrum sharing (MOSS), in accordance with aspects of the present disclosure.

FIGS. 8A, 8B, and 8C depict an example of MOSS, in accordance with aspects of the present disclosure.

FIG. 9 depicts an example of MOSS, in accordance with aspects of the present disclosure.

FIGS. 10A and 10B depict an example of MOSS, in accordance with aspects of the present disclosure.

FIGS. 11A and 11B depict an example of MOSS, in accordance with aspects of the present disclosure.

FIG. 12 depicts an example of MOSS, in accordance with aspects of the present disclosure.

FIG. 13 depicts an example of MOSS, in accordance with aspects of the present disclosure.

FIG. 14 depicts a method for wireless communications.

FIG. 15 depicts a method for wireless communications.

FIG. 16 depicts aspects of an example communications device.

### DETAILED DESCRIPTION

Aspects of the present disclosure relate to wireless communications, and more particularly, to techniques for measurement and initial access for sharing spectrum between mobile network operators.

A mobile network operator (MNO) utilizes spectrum, frequency resources allocated to the MNO, to provide mobile services to its subscriber user equipments (UEs). The spectrum is typically divided into bands, each with specific frequency ranges, and these bands are licensed by regulatory authorities to MNOs. MNOs deploy their network infrastructure to transmit and receive signals within these allocated frequency bands.

MNOs often carefully manage spectrum resources to optimize network performance and accommodate the increasing demand for high-speed data services. Spectrum management typically involves balancing the capacity, coverage, and quality of service (QOS) to meet the diverse needs of subscribers. MNOs participate in spectrum auctions and negotiations with regulatory authorities to acquire additional spectrum or renew existing licenses. The acquisition of new spectrum allows operators to expand their network capacity, improve service quality, and introduce new technologies.

An additional approach to expanding MNO network capacity and coverage is spectrum sharing, where different MNOs share their allocated spectrum. For example, such multi-operator spectrum sharing (MOSS), a first MNO could use a second MNO's spectrum when it is available (i.e., not used by the second MNO) in opportunistic way. While MOSS may improve spectral efficiency and user throughput, one potential challenge is how to coordinate spectrum sharing among MNOs, as well as their subscribed UEs.

Aspects of the present disclosure provide mechanisms for enabling and enhancing spectrum sharing among MNOs using various architectures. The mechanisms proposed herein may be applicable, for example, in a disaggregated radio access network (RAN) architecture, such as an Open RAN (O-RAN) architecture. In O-RAN architectures, mechanisms proposed herein may allow for coordination between distributed units (DUs) and radio units (RUs) of different MNOs involved in the spectrum sharing. The mechanisms may be used in various cases, such as a first case where each MNO has its own fronthaul (FH) and RU for full bandwidth access (including primary subbands of other MNOs) or a second case where each MNO has its own FH/RU for its own primary sub-band and uses inter-MNO coordination to access other MNO primary subbands.

Particular aspects of the subject matter described in this disclosure can be implemented to realize one or more of the following potential advantages. In some examples, the described techniques can be used to improve spectral efficiency and user throughput, by allowing for enhanced spectrum sharing among MNOs and their subscribed UEs.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

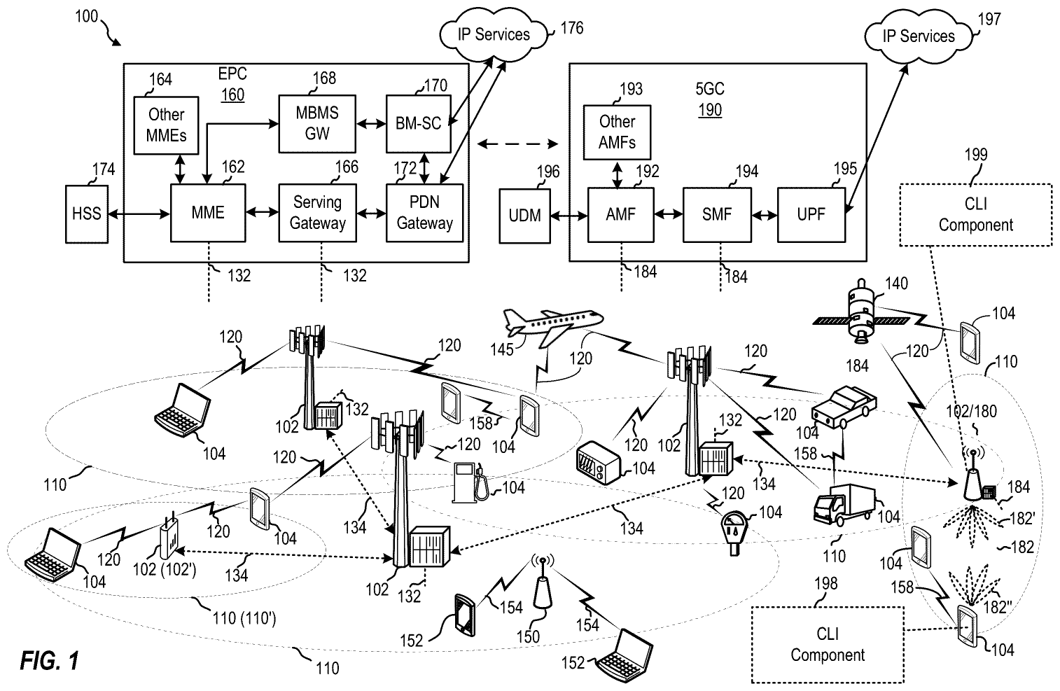

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (CNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

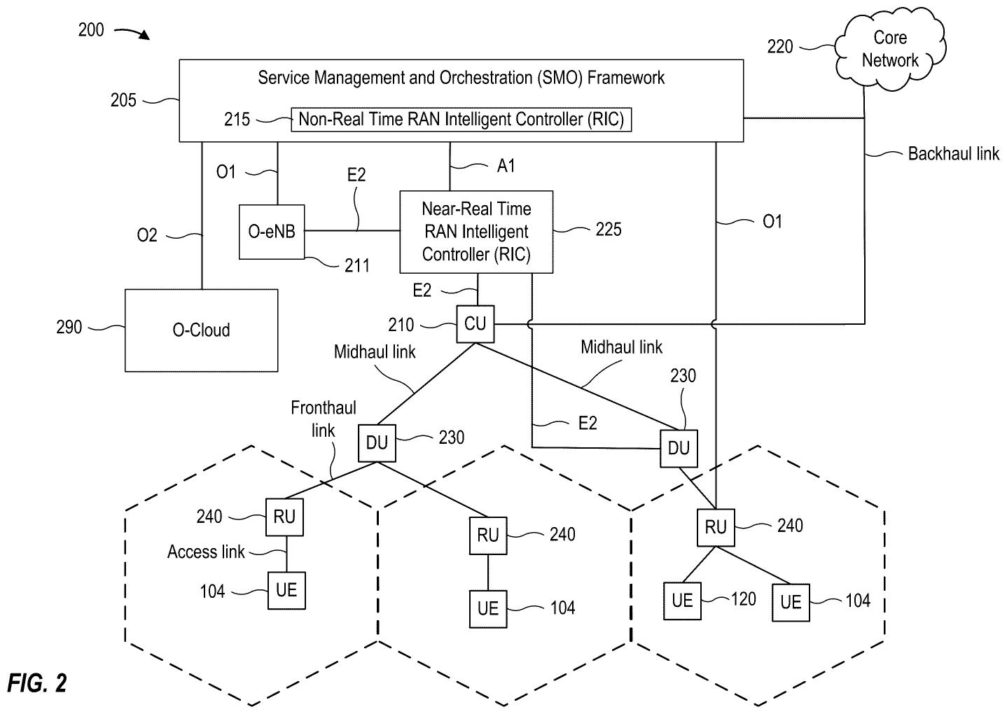

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHZ-71,000 MHZ, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

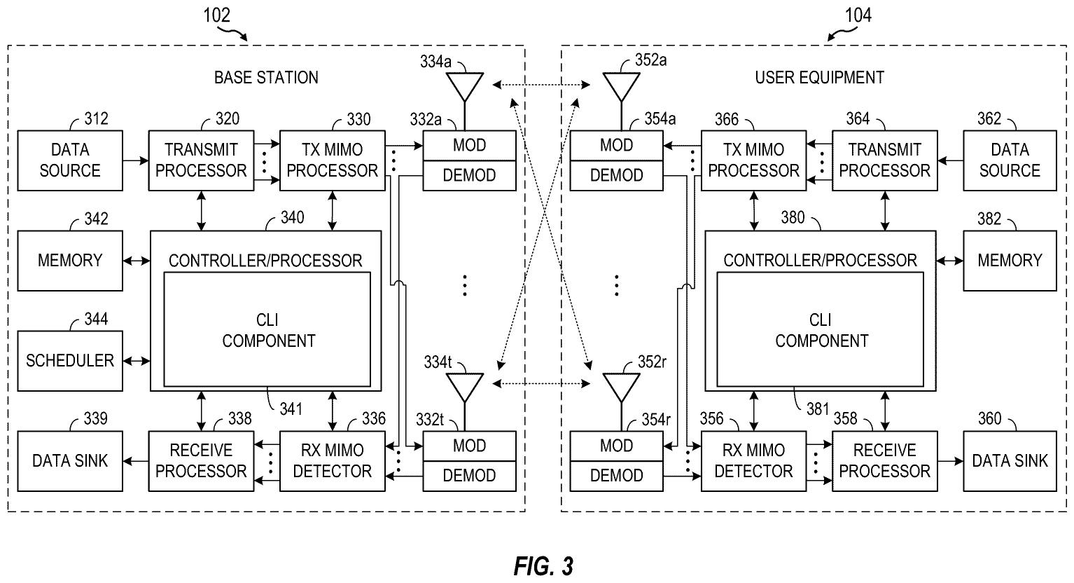

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

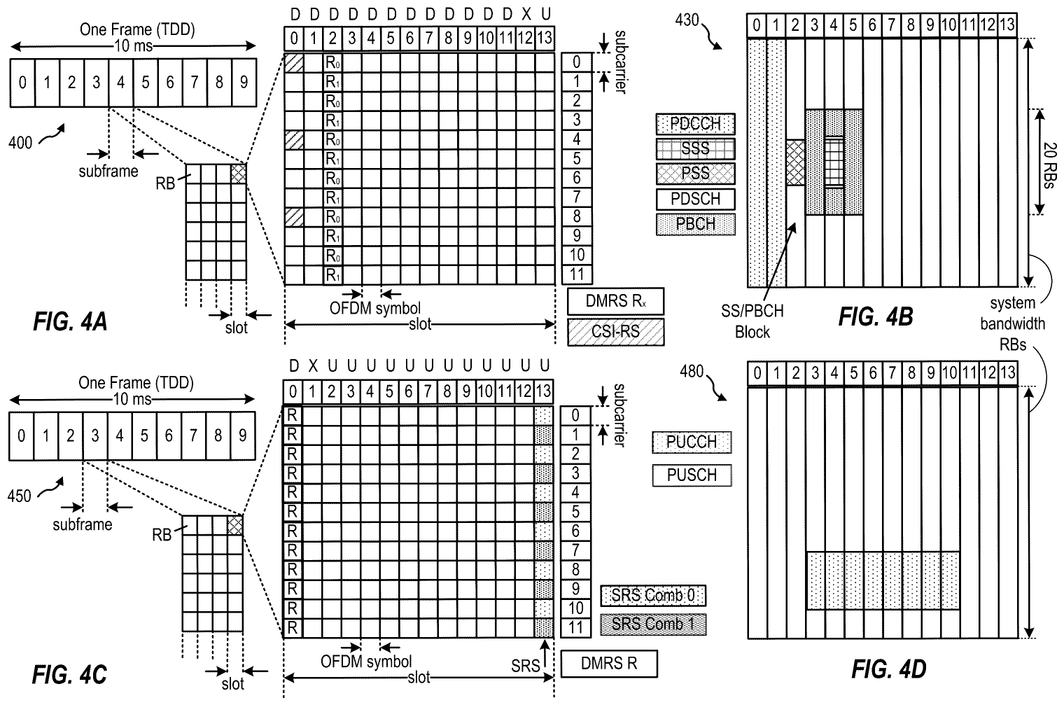

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologics (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Measurement and Initial Access for MOSS

Aspects of the present disclosure relate to wireless communications, and more particularly, to techniques for measurement and initial access for sharing spectrum between mobile network operators.

As noted above, spectrum sharing is one potential approach to expanding MNO network capacity and coverage is spectrum sharing, where different MNOs share their allocated spectrum. With multi-operator spectrum sharing (MOSS) one MNO could use one or more other MNO's spectrum when it is available (i.e., not used by the corresponding MNO) in opportunistic way.

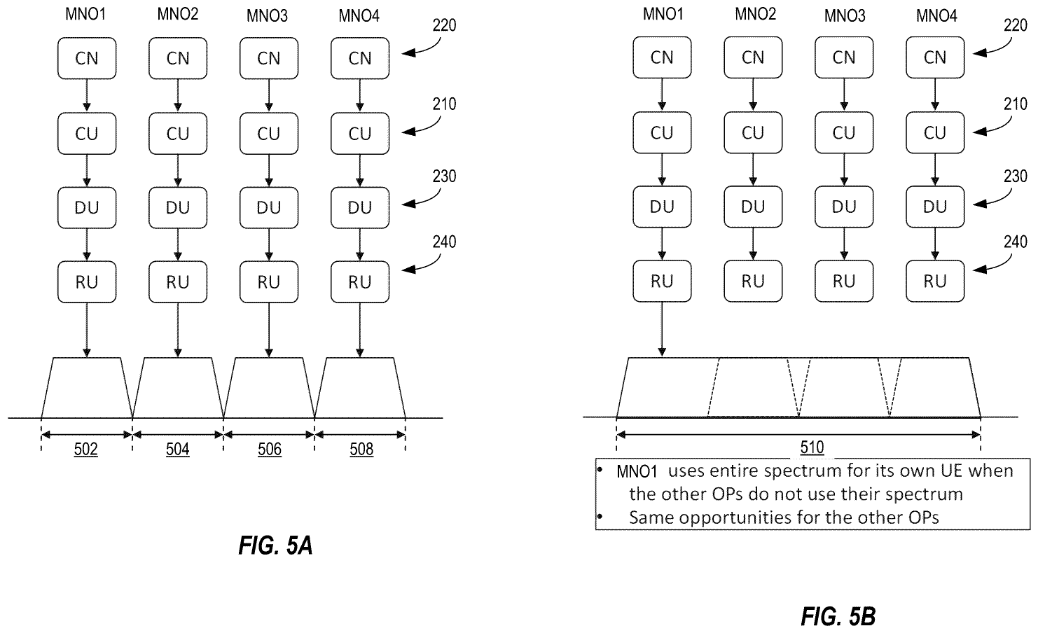

For example, referring to FIGS. 5A and 5B, different MNOs (MNO1, MNO2, MNO3, and MNO4) may be able to share their allocated spectrum (primary subbands 502, 504, 506, and 508). As illustrated in FIG. 5B, MNO1 may be able to use the entire spectrum 510 (spanning subbands 502-508) for its own UE(s) when the other MNOs do not use their spectrum. The other MNOs may similarly use other MNO subbands opportunistically when available.

In this manner, MOSS may improve spectral efficiency and user throughput with coordination among operators. For deployments that utilize an Open RAN (O-RAN) architecture, this coordination may be performed between distributed units (DUs) 230 and radio units (RUs) 240 of different MNOs involved in the spectrum sharing.

While certain examples presented herein describe spectrum sharing among MNOs, the techniques herein may generally be applied to any type of entities capable of sharing spectrum. For example, such entities may include network entities that are associated with particular public land mobile network (PLMN) ID(s) and/or non-public network (NPN) ID(s). In some cases, a single entity (e.g., an MNO or other such entity), may have one or multiple PLMN IDs and/or NPN IDs. In some cases, different such entities (e.g., MNOs or other such entities) may have different PLMN IDs and/or NPN IDs.

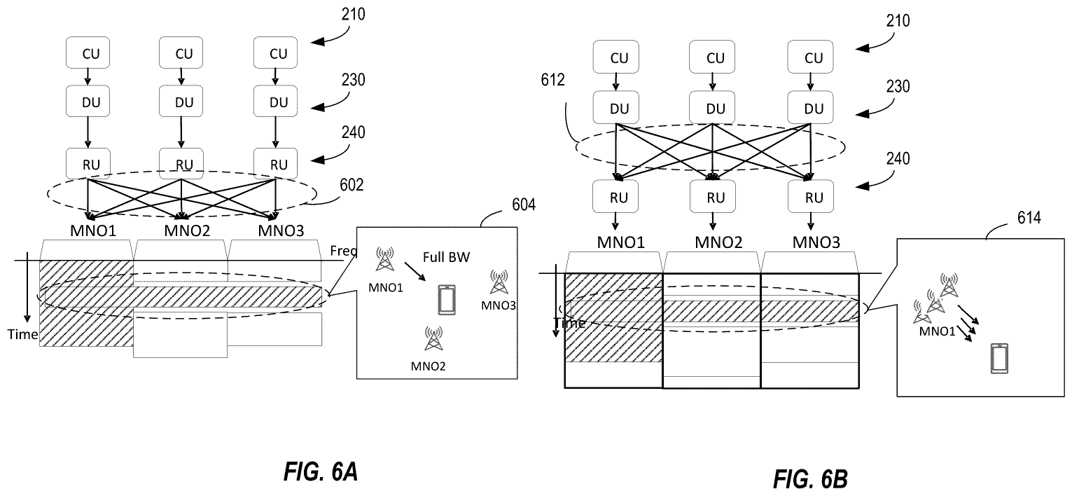

Exactly how the coordination is performed may vary for different deployment scenarios. For example, FIG. 6A illustrates a first scenario where each MNO has its own fronthaul (FH) and RU for full bandwidth access, as indicated at 602. In this scenario, each MNO may have its own tower. An MNO may be able to access bandwidth of other MNOs, when available. For example, as indicated at 604, MNO1 may be able to access the full bandwidth, including primary subbands of MNO2 and MNO3 (which are considered secondary subbands for MNO1) when available.

FIG. 6B illustrates a second scenario where each MNO has its own FH/RU for its own primary sub-band and uses inter-MNO coordination to access other MNO primary subbands, as indicated at 612. In this scenario, MNOs may share a tower. As indicated at 614, in this scenario, an MNO may be able to access bandwidth of other MNOs, when available, via the other MNOs RUs.

Other scenarios are also possible. For example a variant of the first scenario shown in FIG. 6A may involve a FH/RU for full bandwidth provided by a neutral host. Similarly, a variant of the second scenario shown in FIG. 6B may involve a FH/RU for sub-band access and inter-MNO FH provided by a neutral host.

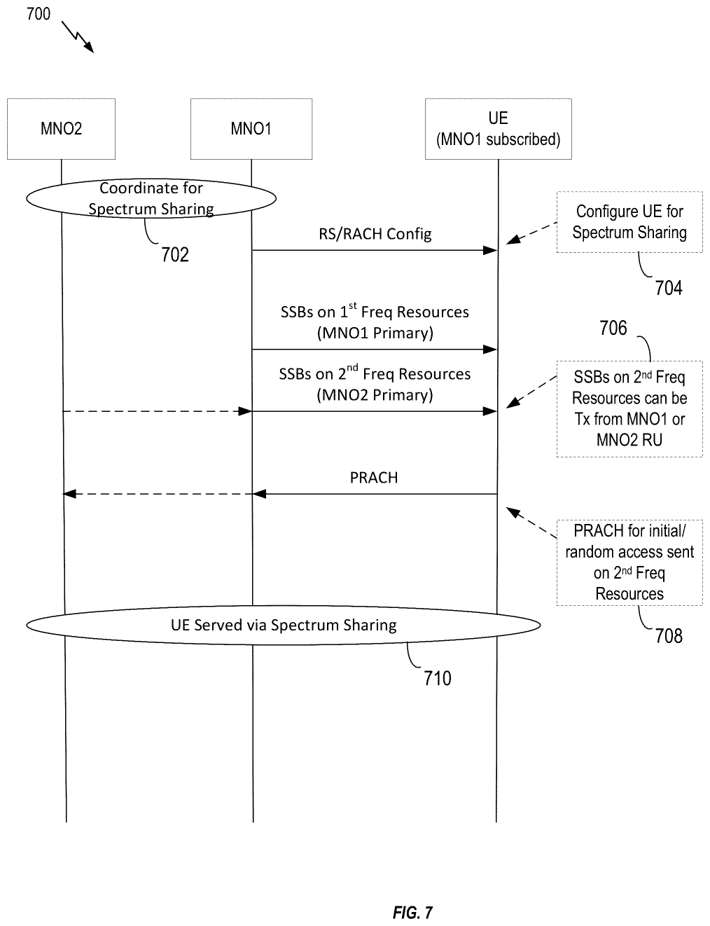

Techniques proposed herein for multi-operator spectrum sharing may be understood with reference to the call flow diagram 700 of FIG. 7. In some aspects, the UE shown in FIG. 7 may be an example of the UE 104 depicted and described with respect to FIGS. 1 and 3. In some aspects, the MNO network entities shown in FIG. 7 may be examples of the BS 102 (e.g., a gNB) depicted and described with respect to FIGS. 1 and 3 or a component (DU/RU) of disaggregated base station depicted and described with respect to FIG. 2.

In the illustrated example, MNO1 participates in spectrum sharing to utilize spectrum of another MNO (MNO2) to serve a UE subscribed to MNO1.

As illustrated at 702, MNO1 and MNO2 may coordinate for spectrum sharing. Details of this coordination may depend on the particular scenario. In some cases, the coordination may involve identifying resources allocated to each MNO, referred to herein as primary subbands, as well as sets of resources to be protected in each primary subband. These resources may include time/frequency resources in the primary subband used for transmission of signals considered essential for downlink (DL) and uplink (UL) transmissions.

As illustrated at 704, MNO1 may configure UE for spectrum sharing. As will be described in greater detail below, this configuration may indicate the primary subbands of MNO2 and corresponding reference signal configurations, allowing the UE to monitor the primary subband of MNO2. The configuration may be conveyed via the primary subband of MNO1 and/or the primary subband of MNO2.

MNO1 may transmit a first set of reference signals on its primary subband and may coordinate with MNO2 to transmit a second set of reference signals on the primary subband of MNO2. For example, as illustrated, MNO1 may transmit a first set of SSBs on its own primary subband and coordinate with MNO2 for transmission of a second set of SSBs on the primary subband of MNO2. As indicated at 706, the second set of SSBs may be transmitted from MNO1 or MNO2, depending on the scenario. For example, MNO1 may get permission to transmit the second set of SSBs itself (e.g., if its own RU has access to MNO2 primary subband per the scenario shown in FIG. 6A) or may ask MNO2 to transmit the second set of SSBs via its RU (e.g., if its own RU does not have access to MNO2 primary subband per the scenario shown in FIG. 6B).

After detecting an SSB (on the MNO1 and/or MNO2 primary subband), the UE may send a PRACH on the MNO2 primary subband. As indicated at 708, the PRACH may be for initial access or random access. The UE may then be served via spectrum sharing (on the primary subband of MNO2), as indicated at 710.

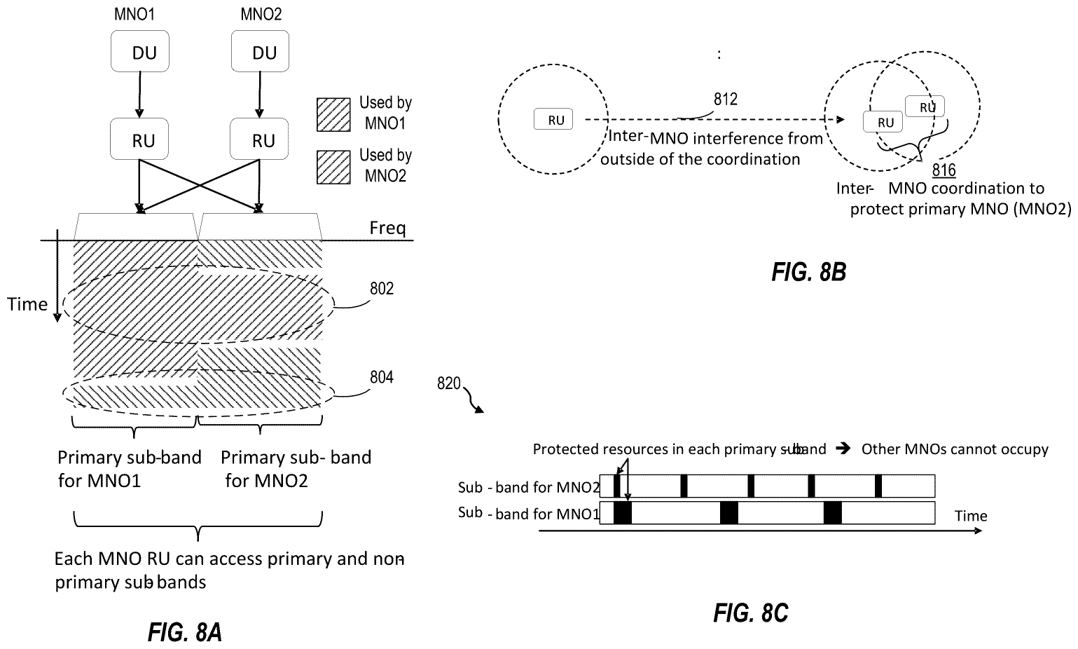

FIGS. 8A-8C illustrate an example of the first scenario described above, where each MNO has its own RUs that can access both primary and non-primary sub-bands. As illustrated in FIG. 8A, to an MNO, a non-primary sub-band may be available only when it is not used by the primary MNO. In other words, the primary sub-band for MNO1 may only be available for MNO2 when it is not used by MNO1. As indicated at 802, however, MNO1 may use MNO2's primary subband when it is not in use by MNO2. Similarly, as indicated at 804, MNO2 may use MNO1's primary subband when it is not in use by MNO1.

As illustrated at 816 in FIG. 8B, local “inter-MNO coordination” may be performed to protect the primary MNO in the sub-band. As indicated at 812, this inter-MNO coordination may not be global, however, and inter-MNO interference may occur outside of this coordination.

As illustrated by diagram 820 in FIG. 8C, a set of resources may be protected in each MNO's primary sub-band. For example, the protected resources may be used for essential DL/UL transmissions that the other MNOs should not occupy (interfere with). Example of these transmissions may include SSBs, tracking reference signals (TRS), channel state information reference signals (CSI-RS)/interference management (IM), physical random access channel (PRACH), system information block (SIB), and paging. In some cases, the protected resources may be identified (based on) inter-MNO/network negotiation (e.g., as part of coordination shown at 702 of FIG. 7), rather than specified in standards.

Reference signal measurements in a primary sub-band can be based on any type of RSs, including periodic, aperiodic, and semi-persistently transmitted RSs.

In some cases, at least periodic RSs on primary sub-bands may be necessary for certain measurements considered essential (e.g., for synchronization, tracking, beam/timing acquisition, power control reference, radio link management (RLM) and/or radio resource management (RRM)).

If a measurement resource is in protected resources, the measurement may exclude inter-MNO interference from RUs deployed by other MNOs outside (not involved in) inter-MNO coordination. This may be beneficial for essential measurements, such as those described above. If a measurement resource is not in the protected resources, the measurement may reflect the interference on the sub-band from the RUs deployed by non-primary MNOs.

Measurements in non-primary sub-bands, on the other hand, may be aperiodic RSs. Periodic resources for measurement RSs may not be guaranteed in non-primary sub-bands. Essential periodic measurements may still use periodic RS on a primary sub-band. Aperiodic measurements for data rate boosting may use aperiodic RS in non-primary sub-bands.

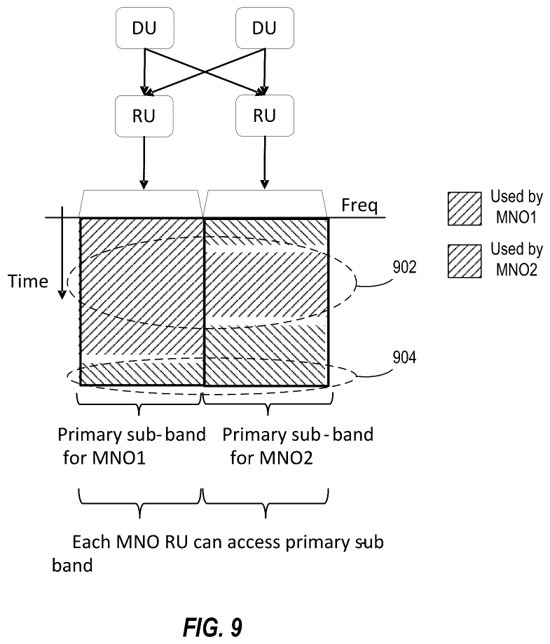

FIG. 9 illustrates an example of the second scenario described above, where an MNO has its own RUs that can access its primary sub-band but may use other MNOs' RUs to access non-primary sub-bands. For example, as indicate at 902, at certain times, MNO1 may use an RU of MNO2 to access the primary sub-band of MNO2. Similarly, as indicate at 904, at certain times, MNO2 may use an RU of MNO1 to access the primary sub-band of MNO1.

As indicated, at a given sub-band, all RUs may be deployed by the same MNO. In this scenario, local “inter-MNO coordination” may be used to protect the primary MNO in the sub-band. Inter-MNO interference from outside the coordination may be less problematic in this scenario, when compared to the first scenario described above, since RU deployment is under control of the primary MNO in the sub-band. As with the first scenario, a set of resources can be protected in primary sub-band for essential DL/UL transmissions (e.g., SSB, TRS, CSI-RS/IM, PRACH, SIB, and Paging) that the other MNOs should avoid. Again, the protected resources may be based on inter-MNO/network negotiation and may not be specified in standards.

For the second scenario, measurements in the primary sub-band may be based on any types of RSs, including periodic, aperiodic, and semi-persistent. As with the first scenario, at least periodic RSs may be used for measurement in the primary sub-band (e.g., for essential measurements). Measurements in non-primary sub-band may also needs periodic RSs. This is because an RU for a non-primary sub-band is different from an RU for a primary sub-band. Thus, each UE may need to be able to get periodic RS on non-primary sub-band.

There are various options for ensuring periodic RSs transmissions on non-primary sub-band from RUs owned by another MNO. For example, according to a first option, a non-primary MNO may receive permission to transmit periodic RSs on non-primary sub-band. In this case a primary MNO may give permission and reserve periodic resources for a non-primary MNO.

A second option may make use of periodic RSs transmitted by the primary MNO on the sub-band. This may make sense as a primary MNO for a sub-band may have to transmit periodic RSs on the sub-band anyway, for its own UEs' mobility/connectivity. Non-primary MNO UEs on the sub-band can be configured to measure the periodic RSs transmitted by the primary MNO.

For both of these options, to measure the periodic RS on a non-primary sub-band in a connected state, UEs of a non-primary MNO may needs to be configured to measure the periodic RSs transmitted in the sub-band (e.g., a UE may be so configured as indicated at 704 in FIG. 7). MNOs may negotiate with each other and, on a given sub-band, a primary MNO may give the necessary configurations of the periodic RSs to non-primary MNO.

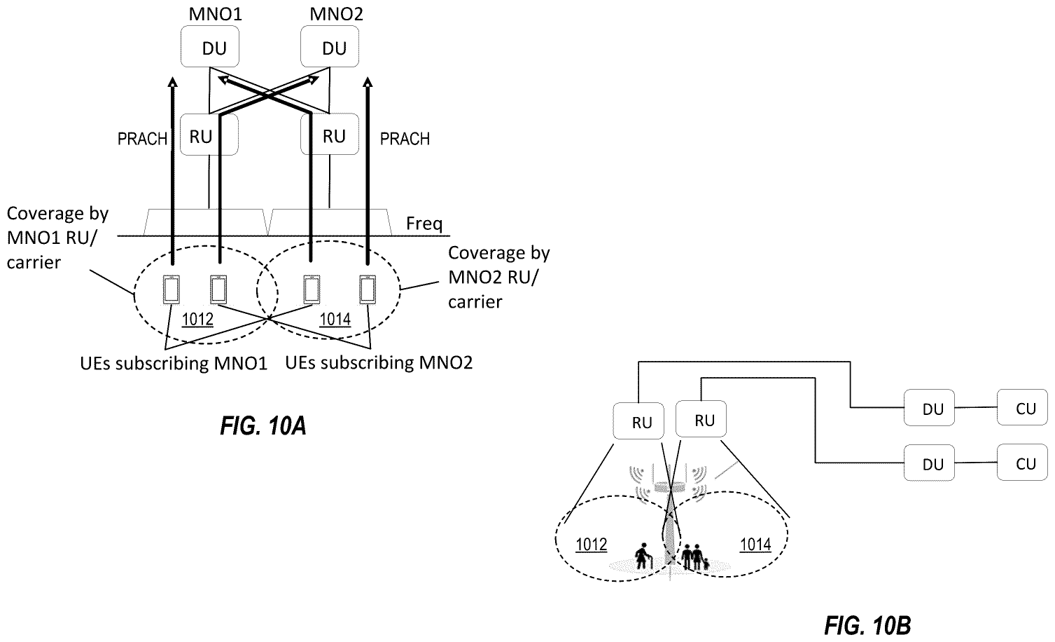

As illustrated in FIG. 10A and FIG. 10B, in some cases, spectrum sharing may enable support for initial and/or random-access on a non-primary sub-band. This would allow an MNO2-subscribed UE in the coverage area 1012 of an MNO1 RU to perform initial/random access in the primary subband of MNO1. Similarly, an MNO1-subscribed UE in the coverage area 1014 of an MNO2 RU could perform initial/random access in the primary subband of MNO2.

In either of the scenarios described above, support of initial/random-access on the primary sub-band may be a default, however. No special handling may be necessary compared for this support, relative to what are available for single-operator non-spectrum-sharing scenario.

For the second scenario, it may be beneficial to enable initial-/random-access on non-primary sub-bands, in which case multi-operator spectrum sharing may be used for coverage extension or for “coverage sharing.” In such cases, as illustrated in FIGS. 10A and 10B, MNOs can cover different areas/sectors by own RUs/spectra, and allow each other to access their RUs/spectra, so that the cooperating MNOs can complement coverages of each other. In some cases, use of each sub-band may still prioritize the MNO who owns the sub-band (e.g., some level of competition among operators may be maintained).

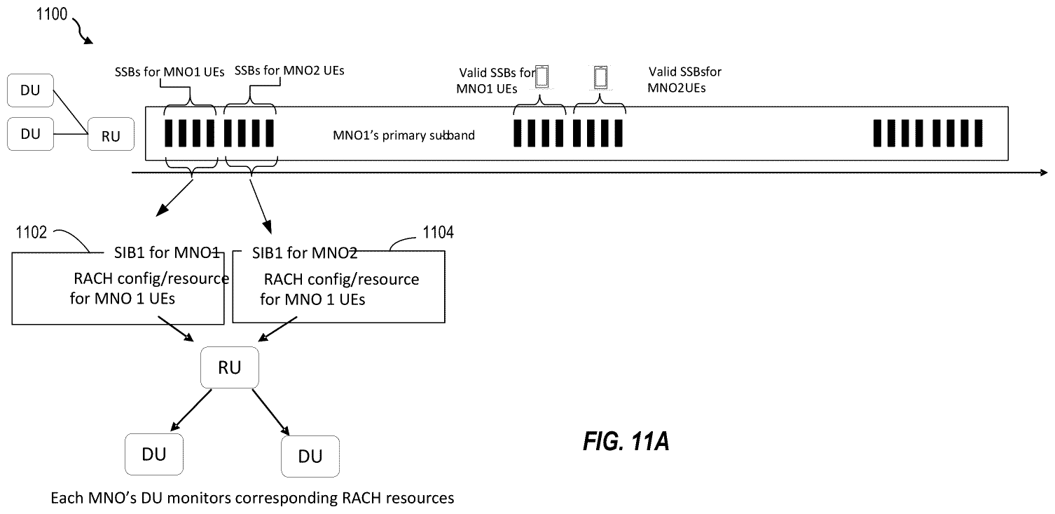

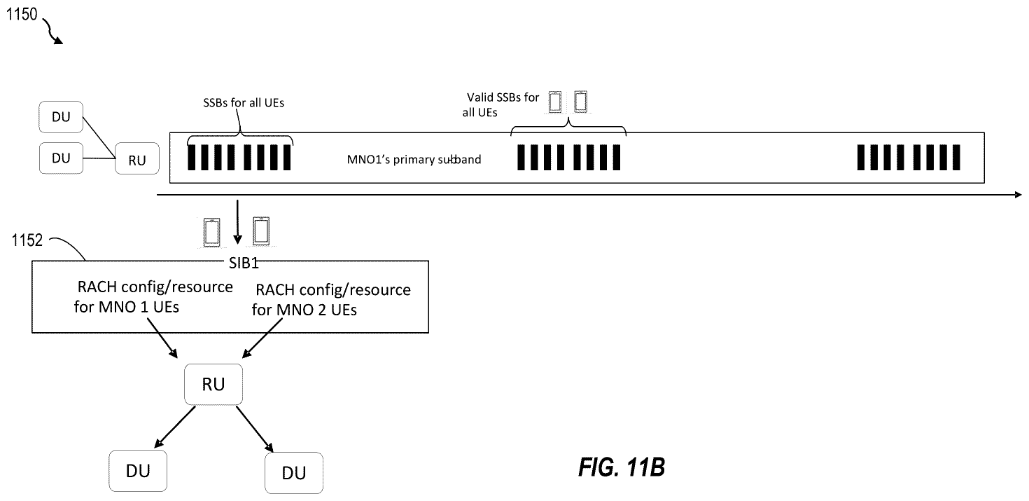

As illustrated in diagram 1100 of FIG. 11, according to a first option, to support initial/random-access on a non-primary sub-band, a primary MNO (e.g., MNO1) may transmit a set of SSBs (e.g., for MNO1-subscribed UEs) and allow non-primary MNO (e.g., MNO2) to transmit another set of SSBs (e.g., for MNO1-subscribed UEs).

Thus, as illustrated, a set of SSBs in an SSB burst may be split into two subsets: one subset for the primary MNO (-subscribed UEs) and the other for non-primary MNO (-subscribed UEs). As indicated at 1102, a corresponding SIB1 for the primary MNO (MNO1) may include a RACH configuration for its (MNO1-subscribed) UEs. Similarly, as indicated at 1104, a corresponding SIB1 for the non-primary MNO (MNO2) may include a RACH configuration for its (MNO2-subscribed) UEs. Each MNO's DU may monitor for (a PRACH transmitted on) corresponding RACH resources.

If the SSBs for different MNOs' UEs are defined using a common synchronization raster, then both MNOs' UEs may be able to detect any of the SSBs. Thus, a UE may need to decode multiple SIB1s on the carrier if it detects multiple SSBs and may have to pick a SIB1 that is valid to the MNO for acquisition. Whether a SIB1 is valid for a UE subscribing to an MNO may be identified by whether the public land mobile network (PLMN) PLMN ID or non-public network (NPN) ID of the MNO is in the plmn-IdentityInfoList or npn-IdentityInfoList of cell-access related information in SIB1.

On the other hand, if the SSBs for different MNOs' UEs are defined using separate/different synchronization rasters (e.g., similar to cell defining SSBs (CD-SSBs) and non-cell defining SSBs (NCD-SSBs) for reduced capacity (RedCap) UEs), each MNO's UEs can detect their own SSBs and may not detect non-designated SSBs. In such cases, however, a UE may need to perform an SSB search over two different synchronization rasters.

In some cases, a primary MNO may reserve resources at least for SSBs and RACH resources for a non-primary MNO in a periodic or semi-static manner. Non-primary MNO's resources not reserved by primary MNO (e.g., except for SSBs and RACH resources) may be available only if these are not used by primary MNO on the sub-band.

As illustrated in diagram 1150 of FIG. 11B, according to a second option, to support initial/random-access on a non-primary sub-band, a primary MNO (e.g., MNO1) may transmit SSBs (for both MNO1 and MNO2) and allow UEs of non-primary MNO to monitor the SSBs. According to this option, each UE monitors the same set of SSBs and receive the same SIB1 and other system information (OSI), regardless of which MNO it subscribes to.

According to this option, as indicated at 1152, the SIB1 in a sub-band for an MNO carries multiple RACH configurations/resources, each associated with one or multiple PLMN IDs or NPN IDs. Thus, a UE subscribing to an MNO (e.g., PLMN ID=1) may refer to the RACH config/resource associated with that PLMN ID=1 for its own initial-/random-access. In this case, SIB1 may carry cell access related information that also includes PLMN IDs or NPN IDs. This may be for the purpose of allowing different MNO's UEs to access to the MNO's network, which may be for different purposes. For example, PLMN/NPN ID in the SIB for RACH-config/resource may be the one not included in the PLMN/NPN ID lists in the SIB for cell access related information.

According to this second option, a primary MNO may reserve resources at least for RACH for non-primary MNO in periodic/semi-static manner. However, a non-primary MNO's resources that are not reserved by a primary MNO (e.g., except for SSBs and RACH resources) may be available (to a non-primary MNO) only if these are not used by primary MNO on the sub-band.

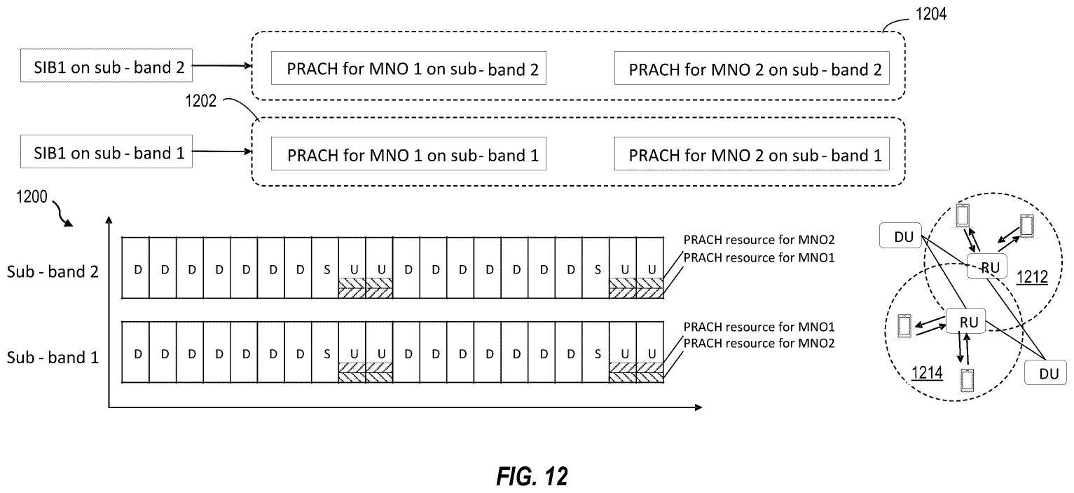

With either of the options described above, a UE may be able to perform initial and/or random access on a non-primary sub-band. Thus, as illustrated in FIG. 12, using RUs of different MNOs can cover different areas (e.g., MNO1 RU can cover area 1212 and MNO2 RU can cover area 1214), a UE can access to the network using either of the RUs. MNOs may reserve resources for RACH (RACH resources) for its own UEs and for the other MNO's UEs in each sub-band. For example, as indicated at 1202, a SIB1 on sub-band 1 may indicate PRACH resources for MNO1 and MNO2 on sub-band 1. Similarly, as indicated at 1204, a SIB1 on sub-band 2 may indicate PRACH resources for MNO1 and MNO2 on sub-band 2. Diagram 1200 illustrates example locations of the PRACH resources (for MNO1 and MNO2 in subband 1 and subband 2) indicated in the SIB1s.

In some cases, downlink information (e.g., SSB, SIB1) may be received on a primary subband, while the uplink transmission (e.g., PRACH, etc.) may be on non-primary sub-bands. This may be useful if UL coverage extension/sharing is enabled.

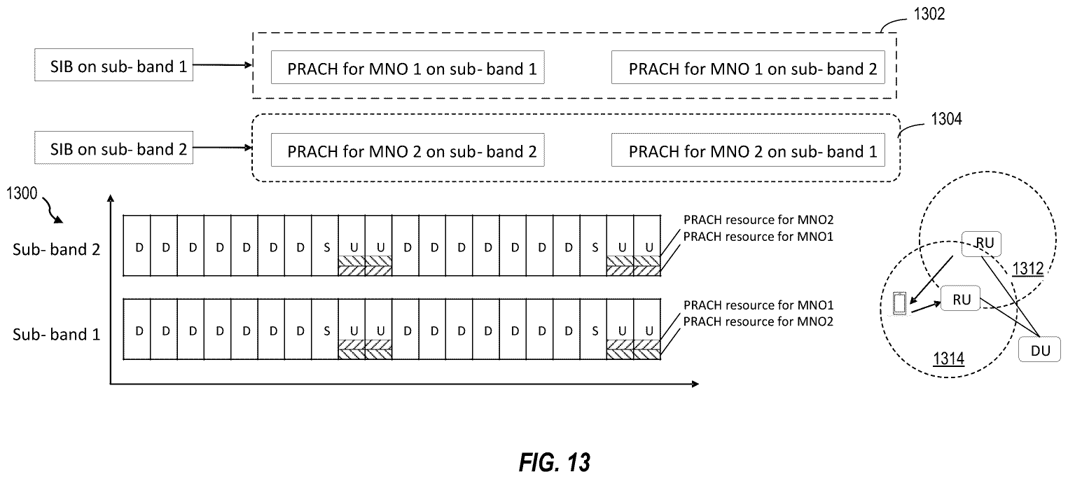

In such cases, as illustrated in FIG. 13, multiple RACH-configurations/resources for primary sub-band and non-primary sub-bands may be included in the SIB in the primary sub-band. For example, as indicated at 1302, a SIB1 on the primary subband for MNO1 (sub-band 1) may indicate PRACH resources for MNO1 on sub-band 1 and the primary subband for MNO2 (sub-band 2). Similarly, as indicated at 1304 a SIB1 on sub-band 2 may indicate PRACH resources for MNO2 on sub-band 1 and sub-band 2. In this manner, for initial/random-access, DL reception may from the primary sub-band, while UL transmission can be toward a non-primary sub-band.

In some cases, signaling may be provided to enable random-access using DL (SSB, SIB1) received on the primary sub-band and UL (PRACH, etc.) on a non-primary. For example, the signaling may indicate that “UL coverage extension/sharing” is enabled. In such cases, multiple RACH-configurations/resources for the primary sub-band and non-primary sub-bands may be included in the SIB in the primary sub-band. For initial/random-access, DL reception may be from the primary sub-band, while UL transmission may be toward a non-primary sub-band.

A UE receiving SIB1 in its primary sub-band may select a sub-band to transmit PRACH for initial-/random-access. In some cases, the selection can be based on a reference signal received power (RSRP) comparison. For example, if RSRP of the primary sub-band is less than a threshold or RSRP of a non-primary sub-band, the UE may select the non-primary subband for transmitting PRACH. For UL transmission on a sub-band from which the UE does not receive SIB, the UE may determine transmit power for the UL transmission (e.g., PRACH), based on a semi-statically configured offset compared to the transmit power for the primary sub-band (e.g., aiming at negative offset to avoid strong interference).

In some cases, since a non-primary sub-band may not guarantee resource availability, it may be beneficial to have a mechanism to enable sub-band (re) selection/switching whenever network/UE wants in a flexible manner. In such cases, the switching may be enabled, for example, by RRC reconfiguration, MAC-CE, and/or DCI format indication. The switching may involve random-access procedure (similar to existing cell-switch/handover), or may involve switching period (similar to lower-layer mobility, UL Tx switching, or BWP switching).

In some cases, the switching may be enabled by UE autonomously. In some cases, based on certain condition(s), the UE may be allowed to switch the sub-band from non-primary to primary. For example, the condition(s) could be that RSRP of primary sub-band is higher than a threshold. In some cases, the switching may involve random-access procedure.

### Example Operations

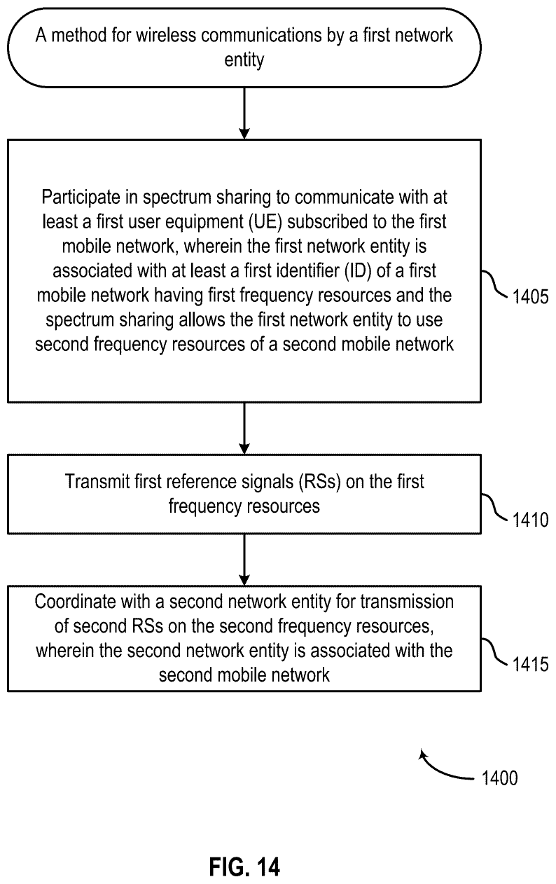

FIG. 14 shows an example of a method 1400 of wireless communications by a first network entity, such as a BS 102 of FIGS. 1 and 3, or a disaggregated base station as discussed with respect to FIG. 2.

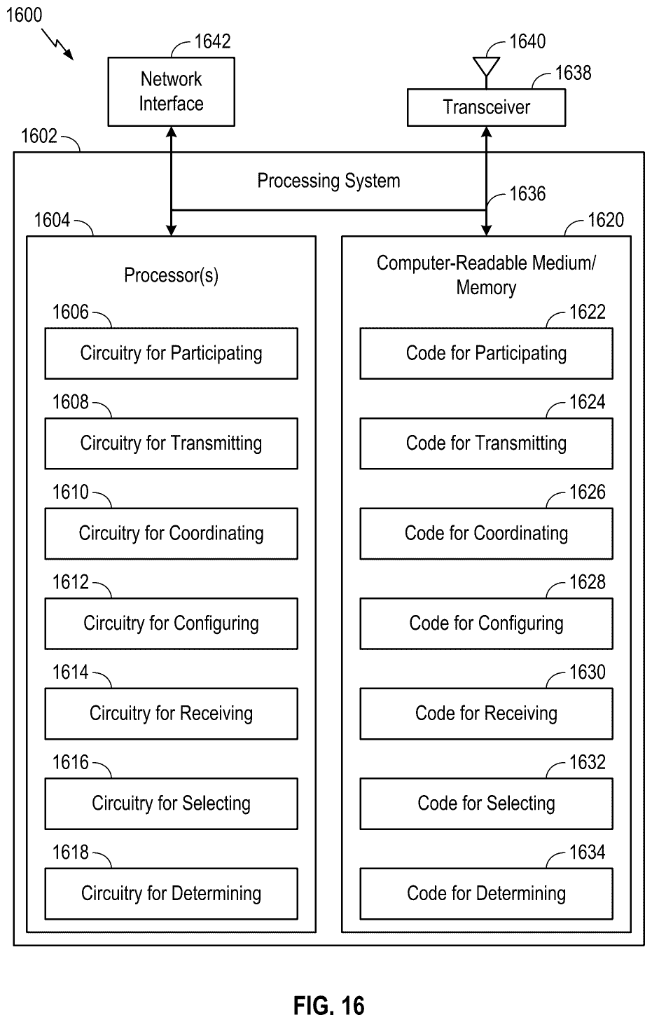

Method 1400 begins at step 1405 with participating in spectrum sharing to communicate with at least a first user equipment (UE) subscribed to the first mobile network, wherein the first network entity is associated with at least a first identifier (ID) of a first mobile network having first frequency resources and the spectrum sharing allows the first network entity to use second frequency resources of a second mobile network. In some cases, the operations of this step refer to, or may be performed by, circuitry for participating and/or code for participating as described with reference to FIG. 16.

Method 1400 then proceeds to step 1410 with transmitting first reference signals (RSs) on the first frequency resources. In some cases, the operations of this step refer to, or may be performed by, circuitry for transmitting and/or code for transmitting as described with reference to FIG. 16.

Method 1400 then proceeds to step 1415 with coordinating with a second network entity for transmission of second RSs on the second frequency resources, wherein the second network entity is associated with the second mobile network. In some cases, the operations of this step refer to, or may be performed by, circuitry for coordinating and/or code for coordinating as described with reference to FIG. 16.

In some aspects, the at least a first ID comprises at least one of: a public land mobile network (PLMN) ID or a non-public network (NPN) ID.

In some aspects, coordinating with the second network entity for transmission of the second RSs on the second frequency resources comprises: communicating with the second network entity to identify a first subset of resources in the second frequency resources that are reserved for the second network entity; and transmitting the second RSs on a second subset of resources in the second frequency resources.

In some aspects, the first reference signals (RSs) are transmitted on the first frequency resources via a first radio unit (RU) associated with the first mobile network; and the first network entity coordinates with the second network entity for transmission of the second RSs on the second frequency resources via a second RU associated with the second mobile network.

In some aspects, the coordinating comprises: transmitting, to the second network entity, a request for permission to transmit the second RSs on the second frequency resources via the second RU; and receiving a response to the request granting the first network entity permission to transmit the second RSs on the second frequency resources via the second RU.

In some aspects, the second RSs comprises RSs transmitted periodically in the time-domain on the second frequency resources by the second mobile network.

In some aspects, the method 1400 further includes configuring the first UE to measure the second RSs transmitted on the second frequency resources. In some cases, the operations of this step refer to, or may be performed by, circuitry for configuring and/or code for configuring as described with reference to FIG. 16.

In some aspects, at least one of the first RSs or the second RSs comprise RSs for synchronization for UEs subscribed to the first mobile network; and the method further comprises participating in at least one of an initial access or random access procedure, involving the second frequency resources with the first UE.

In some aspects, the RSs for synchronization comprise at least one of synchronization signals or synchronization signal blocks (SSBs) that include synchronization signals and physical broadcast channels (PBCH) blocks.

In some aspects, a first set of SSBs for UEs subscribed to the first mobile network and a second set of SSBs for UEs subscribed to the second mobile network are both transmitted on the second frequency resources.

In some aspects, the SSBs transmitted on the second frequency resources are configured to be monitored by both UEs subscribed to the first mobile network and UEs subscribed to the second mobile network; and a system information block (SIB) transmitted in the second frequency resources carries at least a first random access channel (RACH) configuration for UEs subscribed to the first mobile network and a second RACH configuration for UEs subscribed to the second mobile network.

In some aspects, the first RSs comprise SSBs transmitted on the first frequency resources; and participating in at least one of an initial access or random access procedure comprises receiving a physical random access channel (PRACH) on the second frequency resources.

In some aspects, the method 1400 further includes transmitting, on the first frequency resources at least a first random access channel (RACH) configuration associated with at least the first ID, and at least a second RACH configuration associated with a second ID of the second mobile network. In some cases, the operations of this step refer to, or may be performed by, circuitry for transmitting and/or code for transmitting as described with reference to FIG. 16.

In some aspects, the method 1400 further includes transmitting signaling, to a UE, indicating use of the second frequency resources is enabled. In some cases, the operations of this step refer to, or may be performed by, circuitry for transmitting and/or code for transmitting as described with reference to FIG. 16.

In some aspects, the method 1400 further includes receiving signaling, from the UE, indicating that use of the second frequency resources is enabled or is requested to be enabled. In some cases, the operations of this step refer to, or may be performed by, circuitry for receiving and/or code for receiving as described with reference to FIG. 16.

In one aspect, method 1400, or any aspect related to it, may be performed by an apparatus, such as communications device 1600 of FIG. 16, which includes various components operable, configured, or adapted to perform the method 1400.

Communications device 1600 is described below in further detail.

Note that FIG. 14 is just one example of a method, and other methods including fewer, additional, or alternative steps are possible consistent with this disclosure.

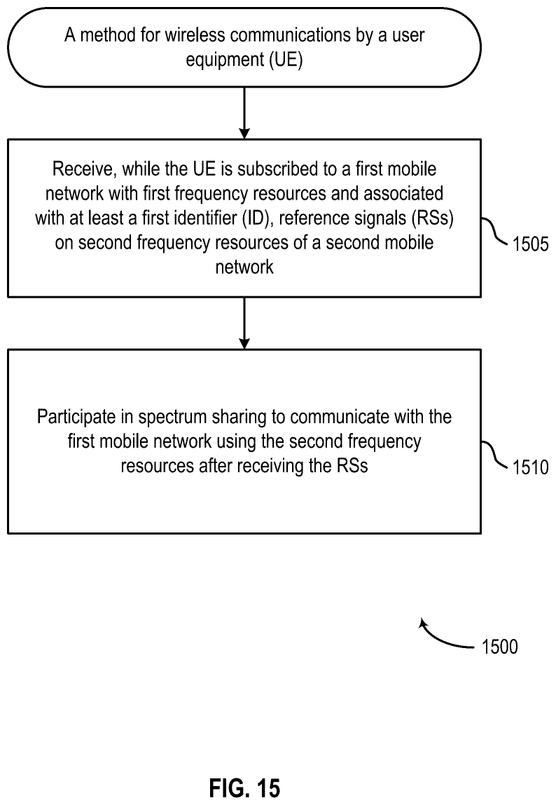

FIG. 15 shows an example of a method 1500 of wireless communications by a user equipment (UE), such as a UE 104 of FIGS. 1 and 3.

Method 1500 begins at step 1505 with receiving, while the UE is subscribed to a first mobile network with first frequency resources and associated with at least a first identifier (ID), reference signals (RSs) on second frequency resources of a second mobile network. In some cases, the operations of this step refer to, or may be performed by, circuitry for receiving and/or code for receiving as described with reference to FIG. 16.

Method 1500 then proceeds to step 1510 with participating in spectrum sharing to communicate with the first mobile network using the second frequency resources after receiving the RSs. In some cases, the operations of this step refer to, or may be performed by, circuitry for participating and/or code for participating as described with reference to FIG. 16.

In some aspects, the at least a first ID comprises at least one of: a public land mobile network (PLMN) ID or a non-public network (NPN) ID.

In some aspects, the RSs are received from a radio unit (RU) associated with the second mobile network.

In some aspects, the RSs comprise RSs transmitted periodically in the time-domain on the second frequency resources by the second mobile network.

In some aspects, the method 1500 further includes receiving signaling configuring the UE to measure the RSs transmitted on the second frequency resources. In some cases, the operations of this step refer to, or may be performed by, circuitry for receiving and/or code for receiving as described with reference to FIG. 16.

In some aspects, the RSs comprise RSs for synchronization for UEs subscribed to the first mobile network; and the method further comprises participating in at least one of an initial access or random access procedure, involving the second frequency resources.

In some aspects, the RSs for synchronization comprise at least one of synchronization signals or synchronization signal blocks (SSBs) that include synchronization signals and physical broadcast channels (PBCH) blocks.

In some aspects, a first set of SSBs for UEs subscribed to the first mobile network and a second set of SSBs for UEs subscribed to the second mobile network are both transmitted on the second frequency resources using a common synchronization raster; and the UE decodes a system information block (SIB) to determine if it is for the first mobile network.

In some aspects, the SSBs transmitted on the second frequency resources are configured to be monitored by both UEs subscribed to the first mobile network and UEs subscribed to the second mobile network; and a system information block (SIB) transmitted in the second frequency resources carries at least a first random access channel (RACH) configuration for UEs subscribed to the first mobile network and a second RACH configuration for UEs subscribed to the second mobile network.

In some aspects, the RSs comprise SSBs transmitted on the first frequency resources; and participating in at least one of an initial access or random access procedure comprises transmitting a physical random access channel (PRACH) on the second frequency resources.

In some aspects, the method 1500 further includes receiving signaling indicating use of the second frequency resources is enabled. In some cases, the operations of this step refer to, or may be performed by, circuitry for receiving and/or code for receiving as described with reference to FIG. 16.

In some aspects, the method 1500 further includes transmitting signaling indicating that use of the second frequency resources is enabled or is requested to be enabled. In some cases, the operations of this step refer to, or may be performed by, circuitry for transmitting and/or code for transmitting as described with reference to FIG. 16.

In some aspects, the method 1500 further includes receiving a system information block (SIB) via the first frequency resources. In some cases, the operations of this step refer to, or may be performed by, circuitry for receiving and/or code for receiving as described with reference to FIG. 16.

In some aspects, the method 1500 further includes selecting the first frequency resources or second frequency resources for transmitting a physical random access channel (PRACH). In some cases, the operations of this step refer to, or may be performed by, circuitry for selecting and/or code for selecting as described with reference to FIG. 16.

In some aspects, the method 1500 further includes determining, if the second frequency resources are selected for transmitting the PRACH, a transmit power for the PRACH based on a transmit power determined for the first frequency resources and an offset value. In some cases, the operations of this step refer to, or may be performed by, circuitry for determining and/or code for determining as described with reference to FIG. 16.

In one aspect, method 1500, or any aspect related to it, may be performed by an apparatus, such as communications device 1600 of FIG. 16, which includes various components operable, configured, or adapted to perform the method 1500. Communications device 1600 is described below in further detail.

Note that FIG. 15 is just one example of a method, and other methods including fewer, additional, or alternative steps are possible consistent with this disclosure.

### Example Communications Device(s)

FIG. 16 depicts aspects of an example communications device 1600. In some aspects, communications device 1600 is a user equipment, such as UE 104 described above with respect to FIGS. 1 and 3. In some aspects, communications device 1600 is a network entity, such as BS 102 of FIGS. 1 and 3, or a disaggregated base station as discussed with respect to FIG. 2.

The communications device 1600 includes a processing system 1602 coupled to the transceiver 1638 (e.g., a transmitter and/or a receiver). In some aspects (e.g., when communications device 1600 is a network entity), processing system 1602 may be coupled to a network interface 1642 that is configured to obtain and send signals for the communications device 1600 via communication link(s), such as a backhaul link, midhaul link, and/or fronthaul link as described herein, such as with respect to FIG. 2. The transceiver 1638 is configured to transmit and receive signals for the communications device 1600 via the antenna 1640, such as the various signals as described herein. The processing system 1602 may be configured to perform processing functions for the communications device 1600, including processing signals received and/or to be transmitted by the communications device 1600.

The processing system 1602 includes one or more processors 1604. In various aspects, the one or more processors 1604 may be representative of one or more of receive processor 358, transmit processor 364, TX MIMO processor 366, and/or controller/processor 380, as described with respect to FIG. 3. In various aspects, one or more processors 1604 may be representative of one or more of receive processor 338, transmit processor 320, TX MIMO processor 330, and/or controller/processor 340, as described with respect to FIG. 3. The one or more processors 1604 are coupled to a computer-readable medium/memory 1620 via a bus 1636. In certain aspects, the computer-readable medium/memory 1620 is configured to store instructions (e.g., computer-executable code) that when executed by the one or more processors 1604, cause the one or more processors 1604 to perform the method 1400 described with respect to FIG. 14, or any aspect related to it; and the method 1500 described with respect to FIG. 15, or any aspect related to it. Note that reference to a processor performing a function of communications device 1600 may include one or more processors 1604 performing that function of communications device 1600.

In the depicted example, computer-readable medium/memory 1620 stores code (e.g., executable instructions), such as code for participating 1622, code for transmitting 1624, code for coordinating 1626, code for configuring 1628, code for receiving 1630, code for selecting 1632, and code for determining 1634. Processing of the code for participating 1622, code for transmitting 1624, code for coordinating 1626, code for configuring 1628, code for receiving 1630, code for selecting 1632, and code for determining 1634 may cause the communications device 1600 to perform the method 1400 described with respect to FIG. 14, or any aspect related to it; and the method 1500 described with respect to FIG. 15, or any aspect related to it.

The one or more processors 1604 include circuitry configured to implement (e.g., execute) the code stored in the computer-readable medium/memory 1620, including circuitry for participating 1606, circuitry for transmitting 1608, circuitry for coordinating 1610, circuitry for configuring 1612, circuitry for receiving 1614, circuitry for selecting 1616, and circuitry for determining 1618. Processing with circuitry for participating 1606, circuitry for transmitting 1608, circuitry for coordinating 1610, circuitry for configuring 1612, circuitry for receiving 1614, circuitry for selecting 1616, and circuitry for determining 1618 may cause the communications device 1600 to perform the method 1400 described with respect to FIG. 14, or any aspect related to it; and the method 1500 described with respect to FIG. 15, or any aspect related to it.

Various components of the communications device 1600 may provide means for performing the method 1400 described with respect to FIG. 14, or any aspect related to it; and the method 1500 described with respect to FIG. 15, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1638 and the antenna 1640 of the communications device 1600 in FIG. 16. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1638 and the antenna 1640 of the communications device 1600 in FIG. 16.

### Example Clauses

Implementation examples are described in the following numbered clauses:

Clause 1: A method for wireless communications by a first network entity, comprising: participating in spectrum sharing to communicate with at least a first user equipment (UE) subscribed to the first mobile network, wherein the first network entity is associated with at least a first identifier (ID) of a first mobile network having first frequency resources and the spectrum sharing allows the first network entity to use second frequency resources of a second mobile network; transmitting first reference signals (RSS) on the first frequency resources; and coordinating with a second network entity for transmission of second RSs on the second frequency resources, wherein the second network entity is associated with the second mobile network.

Clause 2: The method of Clause 1, wherein the at least a first ID comprises at least one of: a public land mobile network (PLMN) ID or a non-public network (NPN) ID.

Clause 3: The method of any one of Clauses 1-2, wherein coordinating with the second network entity for transmission of the second RSs on the second frequency resources comprises: communicating with the second network entity to identify a first subset of resources in the second frequency resources that are reserved for the second network entity; and transmitting the second RSs on a second subset of resources in the second frequency resources, wherein the first and second subsets of resources are non-overlapping.

Clause 4: The method of any one of Clauses 1-3, wherein: the first reference signals (RSs) are transmitted on the first frequency resources via a first radio unit (RU) associated with the first mobile network; and the first network entity coordinates with the second network entity for transmission of the second RSs on the second frequency resources via a second RU associated with the second mobile network.

Clause 5: The method of Clause 4, wherein the coordinating comprises: transmitting, to the second network entity, a request to transmit the second RSs on the second frequency resources via the second RU; and receiving a response to the request allowing the first network entity to transmit the second RSs on the second frequency resources via the second RU.

Clause 6: The method of Clause 4, wherein the second RSs comprises RSs transmitted periodically in the time-domain on the second frequency resources by the second mobile network.

Clause 7: The method of Clause 4, further comprising: configuring the first UE to measure the second RSs transmitted on the second frequency resources.

Clause 8: The method of any one of Clauses 1-7, wherein: at least one of the first RSs or the second RSs comprise RSs for synchronization for UEs subscribed to the first mobile network; and the method further comprises participating in at least one of an initial access or random access procedure, involving the second frequency resources with the first UE.

Clause 9: The method of Clause 8, wherein the RSs for synchronization comprise at least one of synchronization signals or synchronization signal blocks (SSBs) that include synchronization signals and physical broadcast channels (PBCH) blocks.

Clause 10: The method of Clause 9, wherein a first set of SSBs for UEs subscribed to the first mobile network and a second set of SSBs for UEs subscribed to the second mobile network are both transmitted on the second frequency resources.

Clause 11: The method of Clause 9, wherein: the SSBs transmitted on the second frequency resources are configured to be monitored by both UEs subscribed to the first mobile network and UEs subscribed to the second mobile network; and a system information block (SIB) transmitted in the second frequency resources carries at least a first random access channel (RACH) configuration for UEs subscribed to the first mobile network and a second RACH configuration for UEs subscribed to the second mobile network.

Clause 12: The method of Clause 9, wherein: the first RSs comprise SSBs transmitted on the first frequency resources; and participating in at least one of an initial access or random access procedure comprises receiving a physical random access channel (PRACH) on the second frequency resources.

Clause 13: The method of Clause 12, further comprising transmitting, on the first frequency resources at least a first random access channel (RACH) configuration associated with at least the first ID, and at least a second RACH configuration associated with a second ID of the second mobile network.

Clause 14: The method of any one of Clauses 1-13, further comprising at least one of: transmitting signaling, to a UE, indicating spectrum sharing is enabled; or receiving signaling, from the UE, indicating spectrum sharing is enabled or a request to enable spectrum sharing.

Clause 15: A method for wireless communications by a user equipment (UE), comprising: receiving, while the UE is subscribed to a first mobile network with first frequency resources and associated with at least a first identifier (ID), reference signals (RSs) on second frequency resources of a second mobile network; and participating in spectrum sharing to communicate with the first mobile network using the second frequency resources after receiving the RSs.

Clause 16: The method of Clause 15, wherein the at least a first ID comprises at least one of: a public land mobile network (PLMN) ID or a non-public network (NPN) ID.

Clause 17: The method of any one of Clauses 15-16, wherein the RSs are received from a radio unit (RU) associated with the second mobile network.

Clause 18: The method of any one of Clauses 15-17, wherein the RSs comprise RSs transmitted periodically in the time-domain on the second frequency resources by the second mobile network.

Clause 19: The method of any one of Clauses 15-18, further comprising: receiving signaling configuring the UE to measure the RSs transmitted on the second frequency resources.

Clause 20: The method of any one of Clauses 15-19, wherein: the RSs comprise RSs for synchronization for UEs subscribed to the first mobile network; and the method further comprises participating in at least one of an initial access or random access procedure, involving the second frequency resources.

Clause 21: The method of Clause 20, wherein the RSs for synchronization comprise at least one of synchronization signals or synchronization signal blocks (SSBs) that include synchronization signals and physical broadcast channels (PBCH) blocks.

Clause 22: The method of Clause 21, wherein: a first set of SSBs for UEs subscribed to the first mobile network and a second set of SSBs for UEs subscribed to the second mobile network are both transmitted on the second frequency resources using a common synchronization raster; and the UE decodes a system information block (SIB) to determine if it is for the first mobile network.

Clause 23: The method of Clause 21, wherein: the SSBs transmitted on the second frequency resources are configured to be monitored by both UEs subscribed to the first mobile network and UEs subscribed to the second mobile network; and a system information block (SIB) transmitted in the second frequency resources carries at least a first random access channel (RACH) configuration for UEs subscribed to the first mobile network and a second RACH configuration for UEs subscribed to the second mobile network.

Clause 24: The method of Clause 21, wherein: the RSs comprise SSBs transmitted on the first frequency resources; and participating in at least one of an initial access or random access procedure comprises transmitting a physical random access channel (PRACH) on the second frequency resources.

Clause 25: The method of any one of Clauses 15-24, further comprising at least one of: receiving signaling indicating spectrum sharing is enabled; or transmitting signaling indicating spectrum sharing is enabled or a request to enable spectrum sharing.

Clause 26: The method of any one of Clauses 15-25, further comprising: receiving a system information block (SIB) via the first frequency resources; and selecting the first frequency resources or second frequency resources for transmitting a physical random access channel (PRACH).

Clause 27: The method of Clause 26, further comprising determining, if the second frequency resources are selected for transmitting the PRACH, a transmit power for the PRACH based on a transmit power determined for the first frequency resources and an offset value.

Clause 28: An apparatus, comprising: at least one memory comprising executable instructions; and at least one processor configured to execute the executable instructions and cause the apparatus to perform a method in accordance with any one of Clauses 1-27.

Clause 29: An apparatus, comprising means for performing a method in accordance with any one of Clauses 1-27.

Clause 30: A non-transitory computer-readable medium comprising executable instructions that, when executed by at least one processor of an apparatus, cause the apparatus to perform a method in accordance with any one of Clauses 1-27.

Clause 31: A computer program product embodied on a computer-readable storage medium comprising code for performing a method in accordance with any one of Clauses 1-27.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

Means for participating, means for transmitting, means for coordinating, means for receiving, and means for selecting may comprise one or more processors, such as one or more of the processors described above with reference to FIG. 16.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a first network entity, comprising:
at least one memory comprising computer-executable instructions; and
one or more processors configured to execute the computer-executable instructions and cause the first network entity to:
participate in spectrum sharing to communicate with at least a first user equipment (UE) subscribed to the first mobile network, wherein the first network entity is associated with at least a first identifier (ID) of a first mobile network having first frequency resources and the spectrum sharing allows the first network entity to use second frequency resources of a second mobile network;
transmit first reference signals (RSs) on the first frequency resources; and
coordinate with a second network entity for transmission of second RSs on the second frequency resources, wherein the second network entity is associated with the second mobile network.

2. The apparatus of claim 1, wherein the at least a first ID comprises at least one of: a public land mobile network (PLMN) ID or a non-public network (NPN) ID.

3. The apparatus of claim 1, wherein coordinating with the second network entity for transmission of the second RSs on the second frequency resources comprises:
communicating with the second network entity to identify a first subset of resources in the second frequency resources that are reserved for the second network entity; and
transmitting the second RSs on a second subset of resources in the second frequency resources, wherein the first and second subsets of resources are non-overlapping.

4. The apparatus of claim 1, wherein:
the first reference signals (RSs) are transmitted on the first frequency resources via a first radio unit (RU) associated with the first mobile network; and
the first network entity coordinates with the second network entity for transmission of the second RSs on the second frequency resources via a second RU associated with the second mobile network.

5. The apparatus of claim 4, wherein the coordinating comprises:
transmitting, to the second network entity, a request to transmit the second RSs on the second frequency resources via the second RU; and
receiving a response to the request allowing the first network entity to transmit the second RSs on the second frequency resources via the second RU.

6. The apparatus of claim 4, wherein the second RSs comprises RSs transmitted periodically in the time-domain on the second frequency resources by the second mobile network.

7. The apparatus of claim 4, wherein the one or more processors are further configured to execute the computer-executable instructions and cause the first network entity to:
configure the first UE to measure the second RSs transmitted on the second frequency resources.

8. The apparatus of claim 1, wherein:
at least one of the first RSs or the second RSs comprise RSs for synchronization for UEs subscribed to the first mobile network; and
wherein the one or more processors are further configured to execute the computer-executable instructions and cause the first network entity to participate in at least one of an initial access or random access procedure, involving the second frequency resources with the first UE.

9. The apparatus of claim 8, wherein the RSs for synchronization comprise at least one of synchronization signals or synchronization signal blocks (SSBs) that include synchronization signals and physical broadcast channels (PBCH) blocks.

10. The apparatus of claim 9, wherein a first set of SSBs for UEs subscribed to the first mobile network and a second set of SSBs for UEs subscribed to the second mobile network are both transmitted on the second frequency resources.

11. The apparatus of claim 9, wherein:
the SSBs transmitted on the second frequency resources are configured to be monitored by both UEs subscribed to the first mobile network and UEs subscribed to the second mobile network; and
a system information block (SIB) transmitted in the second frequency resources carries at least a first random access channel (RACH) configuration for UEs subscribed to the first mobile network and a second RACH configuration for UEs subscribed to the second mobile network.

12. The apparatus of claim 9, wherein:
the first RSs comprise SSBs transmitted on the first frequency resources; and
participating in at least one of an initial access or random access procedure comprises receiving a physical random access channel (PRACH) on the second frequency resources.

13. The apparatus of claim 12, wherein the one or more processors are further configured to execute the computer-executable instructions and cause the first network entity to transmit, on the first frequency resources at least a first random access channel (RACH) configuration associated with at least the first ID, and at least a second RACH configuration associated with a second ID of the second mobile network.

14. The apparatus of claim 1, wherein the one or more processors are further configured to execute the computer-executable instructions and cause the first network entity to at least one of:
transmit signaling, to a UE, indicating spectrum sharing is enabled; or
receive signaling, from the UE, indicating spectrum sharing is enabled or a request to enable spectrum sharing.

15. An apparatus for wireless communication at a user equipment (UE), comprising:
at least one memory comprising computer-executable instructions; and
one or more processors configured to execute the computer-executable instructions and cause the UE to:
receive, while the UE is subscribed to a first mobile network with first frequency resources and associated with at least a first identifier (ID), reference signals (RSs) on second frequency resources of a second mobile network; and
participate in spectrum sharing to communicate with the first mobile network using the second frequency resources after receiving the RSs.

16. The apparatus of claim 15, wherein the at least a first ID comprises at least one of: a public land mobile network (PLMN) ID or a non-public network (NPN) ID.

17. The apparatus of claim 15, wherein the RSs are received from a radio unit (RU) associated with the second mobile network.

18. The apparatus of claim 15, wherein the RSs comprise RSs transmitted periodically in the time-domain on the second frequency resources by the second mobile network.

19. The apparatus of claim 15, wherein the one or more processors are further configured to execute the computer-executable instructions and cause the UE to:
receive signaling configuring the UE to measure the RSs transmitted on the second frequency resources.

20. The apparatus of claim 15, wherein:
the RSs comprise RSs for synchronization for UEs subscribed to the first mobile network; and
wherein the one or more processors are further configured to execute the computer-executable instructions and cause the UE to participate in at least one of an initial access or random access procedure, involving the second frequency resources.

21. The apparatus of claim 20, wherein the RSs for synchronization comprise at least one of synchronization signals or synchronization signal blocks (SSBs) that include synchronization signals and physical broadcast channels (PBCH) blocks.

22. The apparatus of claim 21, wherein:
a first set of SSBs for UEs subscribed to the first mobile network and a second set of SSBs for UEs subscribed to the second mobile network are both transmitted on the second frequency resources using a common synchronization raster; and
the UE decodes a system information block (SIB) to determine if it is for the first mobile network.

23. The apparatus of claim 21, wherein:
the SSBs transmitted on the second frequency resources are configured to be monitored by both UEs subscribed to the first mobile network and UEs subscribed to the second mobile network; and
a system information block (SIB) transmitted in the second frequency resources carries at least a first random access channel (RACH) configuration for UEs subscribed to the first mobile network and a second RACH configuration for UEs subscribed to the second mobile network.

24. The apparatus of claim 21, wherein:
the RSs comprise SSBs transmitted on the first frequency resources; and
participating in at least one of an initial access or random access procedure comprises transmitting a physical random access channel (PRACH) on the second frequency resources.

25. The apparatus of claim 15, wherein the one or more processors are further configured to execute the computer-executable instructions and cause the UE to at least one of:
receive signaling indicating spectrum sharing is enabled; or
transmit signaling indicating spectrum sharing is enabled or a request to enable spectrum sharing.

26. The apparatus of claim 15, wherein the one or more processors are further configured to execute the computer-executable instructions and cause the UE to:
receive a system information block (SIB) via the first frequency resources; and
select the first frequency resources or second frequency resources for transmitting a physical random access channel (PRACH).

27. The apparatus of claim 26, further comprising, if the second frequency resources are selected for transmitting the PRACH, determining a transmit power for the PRACH based on a transmit power determined for the first frequency resources and an offset value.

28. A method for wireless communications by a first network entity, comprising:
participating in spectrum sharing to communicate with at least a first user equipment (UE) subscribed to the first mobile network, wherein the first network entity is associated with at least a first identifier (ID) of a first mobile network having first frequency resources and the spectrum sharing allows the first network entity to use second frequency resources of a second mobile network;
transmitting first reference signals (RSs) on the first frequency resources; and
coordinating with a second network entity for transmission of second RSs on the second frequency resources, wherein the second network entity is associated with the second mobile network.

29. A method for wireless communications by a user equipment (UE), comprising:
receiving, while the UE is subscribed to a first mobile network with first frequency resources and associated with at least a first identifier (ID), reference signals (RSs) on second frequency resources of a second mobile network; and
participating in spectrum sharing to communicate with the first mobile network using the second frequency resources after receiving the RSs.
